(19) United States
(12) Patent Application Publication
(10) Pub. No.: US 2006/0036721 A1
(43) Pub. Date: Feb. 16, 2006

(54) Run-time tool for network management application

(76) Inventors: Dong Zhao, Lisle, IL (US); Manjula Sridhar, Lisle, IL (US); Edward G. Brunell, Chicago, IL (US); Shankar Krishnamoorthy, Scotch Plains, NJ (US); Xiangyang Shen, Naperville, IL (US)

Correspondence Address: Richard J. Minnich, Esq.;Fay, Sharpe, Fagan, Minnich & McKee, LLP, Seventh Floor, 1100 Superior Avenue, Cleveland, OH, 44114-2518, US

(21) Appl. No.: 10/868,408

(22) Filed: Jun. 15, 2004

(51) Int. Cl. G06F 15/173

(52) U.S. Cl. 709/223

(57) ABSTRACT

In one aspect, a method of monitoring and controlling managed objects within a distributed system by manipulating one or more management application programs is provided. The method includes: providing a run-time tool associated with a management station. The management station is in communication with the distributed system. The run-time tool is in communication with the management application programs. The run-time tool is activated by an activation command having a predetermined syntax. The run-time tool responds to a plurality of input commands, each input command having a predetermined syntax. The run-time tool response to certain input commands is to generate one or more corresponding management application commands and send the generated commands to at least one management application program. Various embodiments of the method are provided. Additionally, an apparatus for monitoring and controlling managed objects within a distributed system by manipulating one or more management application programs is provided.

### CROSS-REFERENCE TO RELATED APPLICATIONS

This application is related to Sridner et al., Attorney Docket No. LUTZ 2 00289 and Lucent Case Name/No. Brunell 2-2-2-2-2, entitled “Resource Definition Language for Network Management Application Development,” filed Jun. 15, 2004, commonly assigned to Lucent Technologies, Inc. and incorporated by reference herein.

This application is related to Brunell et al., Attorney Docket No. LUTZ 2 00324 and Lucent Case Name/No. Brunell 3-3-3-3-3, entitled “View Definition Language for Network Management Application Development,” filed Jun. 15, 2004, commonly assigned to Lucent Technologies, Inc. and incorporated by reference herein.

This application is related to Brunell et al., Attorney Docket No. LUTZ 2 00323 and Lucent Case Name/No. Brunell 4-1-4-4-4-4, entitled “Distribution Adaptor for Network Management Application Development,” filed Jun. 15, 2004, commonly assigned to Lucent Technologies, Inc. and incorporated by reference herein.

This application is related to Zhao et al., Attorney Docket No. LUTZ 2 00325 and Lucent Case Name/No. Brunell 5-2-5-5-5, entitled “Event Management Framework for Network Management Application Development,” filed Jun. 15, 2004, commonly assigned to Lucent Technologies, Inc. and incorporated by reference herein.

This application is related to Sridner et al., Attorney Docket No. LUTZ 2 00326 and Lucent Case Name/No. Brunell 6-1-6-5-6-6, entitled “Managed Object Framework for Network Management Application Development,” filed Jun. 15, 2004, commonly assigned to Lucent Technologies, Inc. and incorporated by reference herein.

This application is related to Shen et al., Attorney Docket No. LUTZ 2 00327 and Lucent Case Name/No. Brunell 7-7-6-7-7, entitled “Data Management and Persistence Frameworks for Network Management Application Development,” filed Jun. 15, 2004, commonly assigned to Lucent Technologies, Inc. and incorporated by reference herein.

This application is related to Sridner et al., Attorney Docket No. LUTZ 2 00328 and Lucent Case Name/No. Brunell 8-2-8-1-8-8, entitled “SNMP Agent Code Generation and SNMP Agent Framework for Network Management Application Development,” filed Jun. 15, 2004, commonly assigned to Lucent Technologies, Inc. and incorporated by reference herein.

### BACKGROUND OF THE INVENTION

The invention generally relates to a network management application and, more particularly, to a run-time tool for monitoring and controlling managed objects in a network via a network management application developed using a resource definition language.

While the invention is particularly directed to the art of network management applications, and will be thus described with specific reference thereto, it will be appreciated that the invention may have usefulness in other fields and applications.

By way of background, Guidelines for Definition of Managed Objects (GDMO) and Structure for Management Information (SMI) are existing standards for defining objects in a network. Managed objects that are defined can be accessed via a network management protocol, such as the existing Simple Network Management Protocol (SNMP). Various standards, recommendations, and guidelines associated with GDMO, SMI, and SNMP have been published. GDMO is specified in ISO/IEC Standard 10165/x.722. Version 1 of SMI (SMIv1) is specified in Network Working Group (NWG) Standard 16 and includes Request for Comments (RFCs) 1155 and 1212. Version 2 of SMI (SMIv2) is specified in NWG Standard 58 and includes RFCs 2578 through 2580. The latest version of SNMP (SNMPv3) is specified in NWG Standard 62 and includes RFCs 3411 through 3418.

ISO/IEC Standard 10165/x.722, GDMO, identifies: a) relationships between relevant open systems interconnection (OSI) management Recommendations/International Standards and the definition of managed object classes, and how those Recommendations/International Standards should be used by managed object class definitions; b) appropriate methods to be adopted for the definition of managed object classes and their attributes, notifications, actions and behavior, including: 1) a summary of aspects that shall be addressed in the definition; 2) the notational tools that are recommended to be used in the definition; 3) consistency guidelines that the definition may follow; c) relationship of managed object class definitions to management protocol, and what protocol-related definitions are required; and d) recommended documentation structure for managed object class definitions. X.722 is applicable to the development of any Recommendation/International Standard which defines a) management information which is to be transferred or manipulated by means of OSI management protocol and b) the managed objects to which that information relates.

RFC 1155, Structure and Identification of Management Information for TCP/IP-based Internets, describes the common structures and identification scheme for the definition of management information used in managing TCP/IP-based internets. Included are descriptions of an object information model for network management along with a set of generic types used to describe management information. Formal descriptions of the structure are given using Abstract Syntax Notation One (ASN.1).

RFC 1212, Concise Management Information Base (MIB) Definitions, describes a straight-forward approach toward producing concise, yet descriptive, MIB modules. It is intended that all future MIB modules be written in this format. The Internet-standard SMI employs a two-level approach towards object definition. An MIB definition consists of two parts: a textual part, in which objects are placed into groups, and an MIB module, in which objects are described solely in terms of the ASN.1 macro OBJECT-TYPE, which is defined by the SMI.

Management information is viewed as a collection of managed objects, residing in a virtual information store, termed the MIB. Collections of related objects are defined in MIB modules. These modules are written using an adapted subset of OSI's ASN.1. RFC 2578, SMI Version 2 (SMIv2), defines that adapted subset and assigns a set of associated administrative values.

The SMI defined in RFC 2578 is divided into three parts: module definitions, object definitions, and, notification definitions. Module definitions are used when describing information modules. An ASN.1 macro, MODULE-IDENTITY, is used to concisely convey the semantics of an information module. Object definitions are used when describing managed objects. An ASN.1 macro, OBJECT-TYPE, is used to concisely convey the syntax and semantics of a managed object. Notification definitions are used when describing unsolicited transmissions of management information. An ASN.1 macro, NOTIFICATION-TYPE, is used to concisely convey the syntax and semantics of a notification.

RFC 2579, Textual Conventions for SMIv2, defines an initial set of textual conventions available to all MIB modules. Management information is viewed as a collection of managed objects, residing in a virtual information store, termed the MIB. Collections of related objects are defined in MIB modules. These modules are written using an adapted subset of OSI's ASN.1, termed the SMI defined in RFC 2578. When designing an MIB module, it is often useful to define new types similar to those defined in the SMI. In comparison to a type defined in the SMI, each of these new types has a different name, a similar syntax, but a more precise semantics. These newly defined types are termed textual conventions, and are used for the convenience of humans reading the MIB module. Objects defined using a textual convention are always encoded by means of the rules that define their primitive type. However, textual conventions often have special semantics associated with them. As such, an ASN.1 macro, TEXTUAL-CONVENTION, is used to concisely convey the syntax and semantics of a textual convention.

RFC 2580, Conformance Statements for SMIv2; defines the notation used to define the acceptable lower-bounds of implementation, along with the actual level of implementation achieved, for management information associated with the managed objects.

Network elements need a way to define managed resources and access/manage those resources in a consistent and transparent way. GDMO does not provide a straight forward approach to defining resources. SMI does not provide for an object-oriented design of network management applications. Neither standard provides sufficient complexity of hierarchy or sufficient complexity of control for management of today's complex networks, particular today's telecommunication networks.

The present invention contemplates a run-time tool for exercising a network management application developed using a resource definition language that resolves the above-referenced difficulties and others.

### SUMMARY OF THE INVENTION

In one aspect, a method of monitoring and controlling managed objects within a distributed system by manipulating one or more management application programs associated with the distributed system is provided. In one embodiment, the method includes: a) providing a run-time tool associated with a management station, wherein the management station is in communication with the distributed system and the run-time tool is in communication with the one or more management application programs, wherein the run-time tool is activated by an activation command having a predetermined syntax, wherein the run-time tool responds to a plurality of input commands, each input command having a predetermined syntax, wherein the run-time tool response to certain input commands is to generate one or more corresponding management application commands and send the generated management application commands to at least one management application program based on the input command, b) activating the run-time tool in response to receiving a first activation command, c) receiving a first input command, d) parsing the first input command to determine whether the first input command is in accordance with a corresponding predetermined syntax, e) when the first input command is in accordance with the corresponding predetermined syntax, generating one or more management application commands based on the parsed first input command, and f) sending the one or more generated management application commands to at least one management application program, wherein the management application program(s) to which the one or more generated management application commands are sent is based on the first input command.

In another embodiment, the method includes: a) providing a run-time tool associated with a management station, wherein the management station is in communication with the distributed system and the run-time tool is in communication with the one or more management application programs, wherein the run-time tool is activated by an activation command having a predetermined syntax, wherein the run-time tool responds to a plurality of input commands, each input command having a predetermined syntax, wherein the run-time tool response to certain input commands is to generate one or more corresponding management application commands and send the generated management application commands to at least one management application program based on the input command, b) activating the run-time tool in response to receiving a first activation command with a parameter identifying a script file containing a list of input commands, c) retrieving a first input command from a first end of the list of input commands in the script file, d) parsing the first input command to determine whether the first input command is in accordance with a corresponding predetermined syntax, e) when the first input command is in accordance with the corresponding predetermined syntax, generating one or more management application commands based on the parsed first input command, f) sending the one or more generated management application commands to at least one management application program, wherein the management application program(s) to which the one or more generated management application commands are sent is based on the first input command, and g) repeating steps c)-g) for each input command in the list of input commands advancing sequentially from the first end of the list of input commands to a second end.

In another aspect, an apparatus for monitoring and controlling managed objects within a distributed system by manipulating one or more management application programs associated with the distributed system is provided. In one embodiment, the apparatus includes: a run-time tool associated with a management station, wherein the management station is in communication with the distributed system and the run-time tool is in communication with the one or more management application programs, wherein the run-time tool is activated by an activation command having a predetermined syntax, wherein the run-time tool responds to a plurality of input commands, each input command having a predetermined syntax, wherein the run-time tool response to certain input commands is to generate one or more corresponding management application commands and send the generated management application commands to at least one management application program based on the input command, means for activating the run-time tool in response to receiving a first activation command, means for receiving a first input command, means for parsing the first input command to determine whether the first input command is in accordance with a corresponding predetermined syntax, means for generating one or more management application commands based on the parsed first input command when the first input command is in accordance with the corresponding predetermined syntax, and means for sending the one or more generated management application commands to at least one management application program, wherein the management application program(s) to which the one or more generated management application commands are sent is based on the first input command.

Benefits and advantages of the invention will become apparent to those of ordinary skill in the art upon reading and understanding the description of the invention provided herein.

### DESCRIPTION OF THE DRAWINGS

The present invention exists in the construction, arrangement, and combination of the various parts of the device, and steps of the method, whereby the objects contemplated are attained as hereinafter more fully set forth, specifically pointed out in the claims, and illustrated in the accompanying drawings in which:

FIG. 1 is a block diagram of an embodiment of a reusable asset center (RAC) development environment for development of network management applications.

FIG. 2 is a block diagram of an embodiment of a run-time network management environment with network management applications developed by the RAC development environment.

FIG. 3 is a block diagram of an embodiment of a resource definition language file(s) block of the RAC development environment.

FIG. 4 is a block diagram of an embodiment of a parser(s) block of the RAC development environment.

FIG. 5 is a block diagram of an embodiment of an options block of the RAC development environment.

FIG. 6 is a block diagram of an embodiment of a code generator(s) block of the RAC development environment.

FIG. 7 is a block diagram of an embodiment of a RAC management framework block of the RAC development environment.

FIG. 8 is a block diagram of an embodiment of a run-time tool(s) block of the RAC development environment.

FIG. 9 is a block diagram of an embodiment of a run-time network management environment with a command line interpreter in communication with network management applications developed by the RAC development environment.

FIG. 10 is a block diagram of an embodiment of the command line interpreter depicted in FIG. 9.

FIG. 11 is a flowchart of an operational process for an embodiment of the command line interpreter depicted in FIG. 9.

### DETAILED DESCRIPTION OF THE PREFERRED EMBODIMENTS

Referring now to the drawings wherein the showings are for purposes of illustrating the preferred embodiments of the invention only and not for purposes of limiting same.

In general, a reusable asset center (RAC) development environment for network management application development is provided. RAC, as used herein, generically refers to a reusable set of frameworks for network management application development. The set of frameworks is referred to as the RAC management framework. Network, as used herein, generically refers to a system having a set of resources arranged in a distributed architecture. For example, the RAC development environment may be used to develop network management applications for a TCP/IP-based network or any other type of communication network. For example, the RAC development environment may be used to develop network management applications for landline and/or wireless telecommunication networks. Likewise, the RAC development environment may be used to develop management applications for any type of system having a distributed architecture. Defined as such, the RAC framework is inherently reusable in other networks (i.e., systems). Moreover, major portions of code used to build management applications in the RAC development environment are inherently reusable.

The RAC development environment includes a Managed Object Definition Language (MODL) to specify managed objects in a network or system design and management information associated with the managed objects. The syntax for MODL is object-oriented and the semantics are similar to GDMO. This provides a simplified language for defining data models and acts as a single point translation mechanism to support interacting with different schema types. In essence, MODL provides a protocol-independent mechanism for accessing management information for managed objects within the network design. MODL can be used to define data models describing the managed resources of the network design in terms of managed resources having managed objects, define data types (attributes) representing various resources and objects, and define relationships among the managed resources and objects.

MODL allows network management applications to specify the resources to be managed in a given network design. The RAC development environment also includes MODL code generation from MODL files defining the managed objects and information. This provides automatically generated code to access these resources. Network management application developers can choose to make these resources persistent or transient. Developers can choose among various options to customize the code generation to suit the needs of the operators/maintainers (i.e., providers) of the network. MODL is object-oriented and allows applications to capture complex resources in a systematic way.

The RAC management framework provides an operation, administration, and maintenance (OAM) management framework catering to common OAM needs of the network and its managed resources and objects. The services offered by the RAC management framework range from standard system management functions to generic functions, such as event management, SNMP proxy interface, persistency services, and view management. These services are offered in a protocol-independent and operating system-independent manner.

Most of the common OAM needs of network elements are described in the ITU-T specifications X-730 through X-739 and are known as system management functions. The process leading to development of a RAC management framework provides for systematic and consistent reuse of code. In addition to requirements prescribed by applicable standards, the RAC management framework also provides, for example, functionalities such as persistence, view management and SNMP interface capabilities.

The following requirements of ITU-T X.730 (ISO/IEC 10164-1: 1993(E)) associated with Object Management Function (OMF) services are fully supported in the RAC management framework: 1) creation and deletion of managed objects; 2) performing actions upon managed objects; 3) attribute changing; 4) attribute reading; and 5) event reporting. The RAC management framework also provides, for example, ITU-T X.731-like state management functionality through effective use of callbacks and event reporting.

The RAC management framework provides, for example, a minimal subset of attributes for representing relations as described in ITU-T X.732 (ISO/IEC 10164-3). Certain attributes in the RAC management framework provide, for example, ways to define and create parent and child relationships between managed resources. This enables developers to specify hierarchical structures in the data model representing the network design.

The RAC management framework includes a standalone event management framework to implement event-handling services as described by ITU-T X.734 (ISO/IEC 10164-5). Regarding event-handling services, the RAC management framework, for example, permits: 1) definition of a flexible event report control service that allows systems to select which event reports are to be sent to a particular managing system, 2) specification of destinations (e.g. the identities of managing systems) to which event reports are to be sent, and 3) specification of a mechanism to control the forwarding of event reports, for example, by suspending and resuming the forwarding.

In addition to standard services, the RAC management framework provides additional capabilities associated with the functionality of various potential network elements. The RAC management framework also provides facilities to maintain data integrity in terms of default values and range checks and persistency of managed resources. For example, managed objects can be made persistent and all the OMF services are supported on these persistent managed objects. The managed objects can be manipulated from the back-end using standard Java database connectivity (JDBC) interfaces and synchronization is maintained so as to retain data integrity. This enables developers to manipulate data from multiple interfaces.

The RAC management framework provides a concept of views and view management services. Many network management applications, especially client applications, do not want to access or store the information about all the objects in the data model. The concept of views in the RAC management framework allows developers to create network management applications with access to a subset of the data model. Network management application developers can specify a view using a View Definition Language (VDL) that is included in the RAC development environment. View management services can be used to manage a cross-section of managed objects and associated resources in a single unit called a View. Most of the OMF services are also provided through the views.

The RAC management framework allows transparent distribution of the network management application. This decouples the network management application from changes in platforms and middleware environments. The network management application can be deployed in agent clients and agent servers servicing operation and maintenance centers (OMCs) (i.e., managers). The interface to the OMC can be Common Object Request Broker Architecture (CORBA), SNMP, JDBC, or another standard communication protocol for network management. For example, by simple inheritance, the agent server interface to the OMC can be extended to support other network management protocols, such as common management information protocol (CMIP), extensible markup language (XML), etc.

One of the key advantages for developers is that the RAC development environment automates development of portions of code with respect to the overall network management application. The RAC development environment generates the code based on the data model defined in MODL. The objects in the model get translated into subclasses in MODL code and access to the objects is generated using a build process in the RAC development environment. If the data model changes, corresponding MODL files can be revised and corresponding MODL code can be re-generated. Thus, streamlining change management of the network management application. The revised network management application is provided in a consistent and controlled manner through the object-oriented programming characteristics of MODL and the RAC management framework.

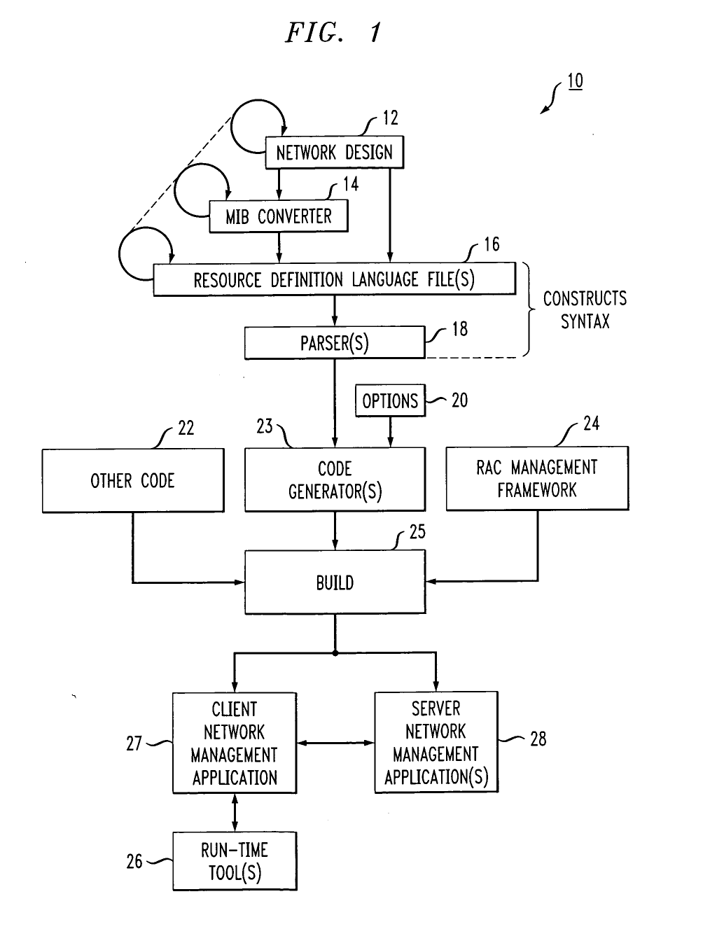

With reference to FIG. 1, a RAC development environment 10 includes a network design 12, an MIB converter 14, a resource definition language file(s) block 16, a parser(s) block 18, an options block 20, an other code block 22, a code generator(s) block 23, a RAC management framework block 24, a build process 25, a run-time tool(s) block 26, a client network management application 27, and a server network management application(s) 28. The RAC development environment 10 also includes computer hardware for storing and/or operating the various software development processes shown in FIG. 1. The computer hardware used in conjunction with the RAC development environment 10 may range from a network with multiple platforms to a stand-alone computer platform. The various processes for software development described herein may operate on any suitable arrangement of various types of computer equipment with various types of operating systems and various types of communication protocols. Thus, it is to be understood that the software development processes described herein do not require any specialized or unique computer architecture for the RAC development environment 10. The RAC development environment 10 represents an exemplary development cycle used by developers when preparing network management applications. Typically, developers begin with a design or data model for a network or system. This is depicted by the network design 12 and may include any design documentation describing the network and its resources or elements that is useful to the developers (i.e., data model). The network design 12 may include an existing MIB for one or more network resources.

If the network design 12 includes one or more MIBs, the MIB converter 14 converts the information in the MIBs to resource definition language file(s) 16. The developers use the network design 12 as source data for representing the remaining network resources and objects to be managed in the resource definition language file(s) block 16. The developers may also use the network design 12 to integrate the file(s) created by the MIB converter 14 with the other file(s) in the resource definition language file(s) block 18. Thus, the resource definition language file(s) block 16 includes one or more files defining the resources and objects within constructs and in appropriate syntax for one or more resource definition languages associated with the RAC development environment 10. Additional files may be included in the resource definition language file(s) block 18 defining one or more views of the resources and/or objects.

Files from the resource definition language file(s) block 18 are provided to an appropriate parser in the parser(s) block 18 to check for construct and syntax compliance and to build a parse tree. The parse tree is provided to the code generator(s) block 23. The options block 20 specifies certain options related to code generation by the code generator(s) block 23. The code generation options are customized by the developers based on the network design, parse tree, developer preferences, and/or network management application customer/user preferences.

The code generator(s) block 23 generates code for each managed resource and object defined in the resource definition language file(s) 16. The generated code provides various hooks and callbacks, which can be used by the developers to customize the flow of operations and behavior of the network management applications. The generated code primarily includes extensions of RAC management framework classes and eases the burden of coding and maintaining repeated functionality. The RAC management framework block 24 includes code organized in a group of subordinate frameworks. The RAC management framework 24 is implemented as a set of interrelated patterns (i.e., frameworks) that provide common functionality which can be selectively associated with the managed resources/objects and included in the generated code. The other code block 22 includes, for example, user-specific code and main methods which perform the initialization to get the final network management application.

The generated code from the code generator(s) block 23 is compiled and linked with code from the other code block 22 and the RAC management framework block 24 in the build process 25 to create a client network management application 27 and one or more server network management applications 28. At any stage in the application development, developers can add, delete or modify the managed resources/objects in the resource definition language files, re-generate the resource definition language code with new and/or revised managed resources/objects, and re-build the network management applications.

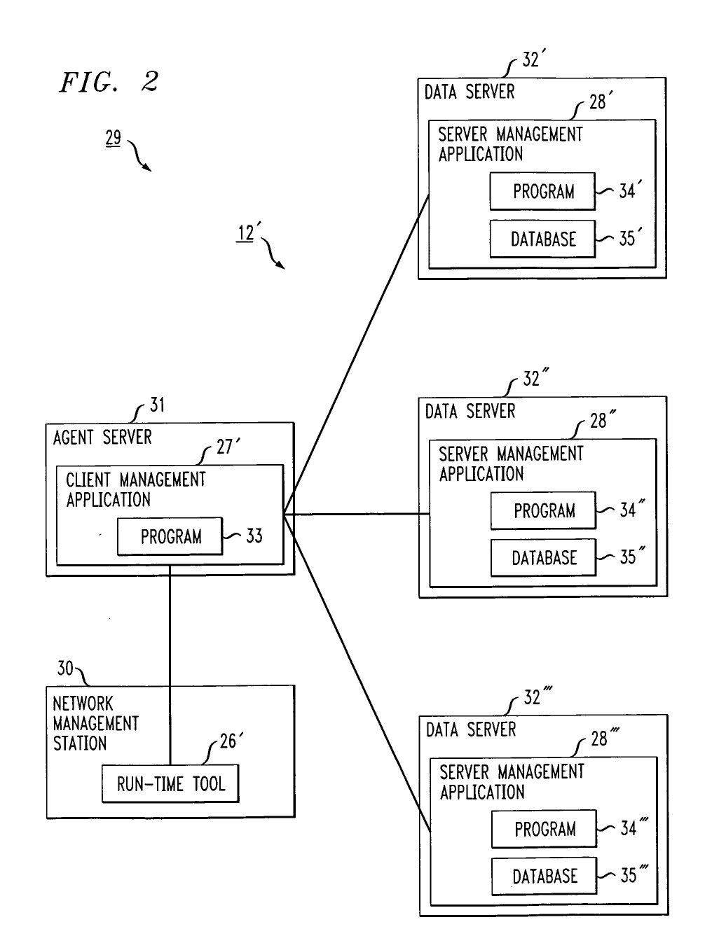

With reference to FIG. 2, an embodiment of a run-time network management environment 29 includes a network design 12′ to be managed in communication with a network management station 30. The network design includes an agent server 31 in communication with a first data server 32′, a second data server 32″, and a third data server 32′″. The network management station 30 includes an embodiment of the run-time tool 26′. The agent server 31 includes an embodiment of the client network management application 27′. The data servers 32′, 32″, 32′″ each include a corresponding embodiment of the server network management application 28′, 28″, 28′″. The client network management application 27′ includes an application program 33. Each server network management application 28′,28″,28′″ includes a corresponding application program 34′, 34″, 34′″ and management database 35′, 35″, 35′″.

Each of the data servers 32′, 32″, 32′″ includes one or more objects to be managed. For example, if any two network resources 32 are the same and the objects to be managed for both resources are also the same, the corresponding server network management application 28 may be the same on both resources. Otherwise, the application programs 34 and management databases 35 in the client network management applications are different based on the type of resource and/or type of objects to be managed.

The run-time tool 26′ controls and monitors the data servers 32′, 32″, 32′″ through communications with the client network management application 27′. The client network management application 27′ passes communications from the run-time tool 26′ to the appropriate server network management application 34. The client network management application 27′ also passes communications from the server network management applications 34′, 34″, 34′″ to the run-time tool 26′.

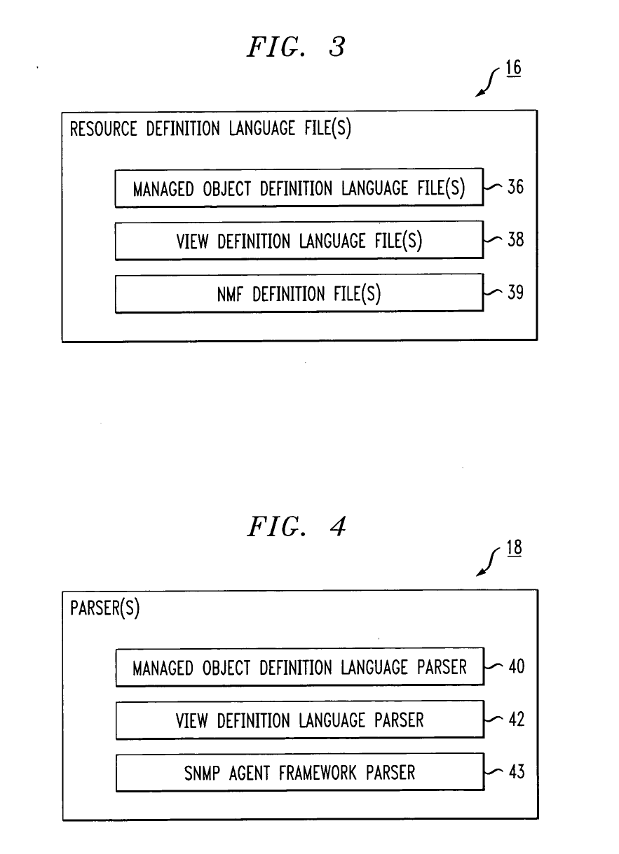

With reference to FIG. 3, an embodiment of the resource definition language file(s) block 16 includes managed object definition language (MODL) file(s) 36, view definition language (VDL) file(s) 38, and network management forum (NMF) file(s) 39. The VDL file(s) 38 are optional. MODL is a language used to organize the managed resources. MODL allows for definition of managed resources as managed object classes. The MODL file(s) 36 include constructs to organize the data model of the network design into managed object classes. This facilitates readability and provides a mechanism for abstracting the managed resources in the network design. VDL is a specification language based on MODL that describes managed object views. Each VDL file 38 (i.e., managed object view) is a collection of managed attributes that are scattered across various managed objects. The VDL file(s) 38 are entities that are essentially wrappers for corresponding managed objects included in the respective managed object views. The NMF file(s) 39 acts as an input for generating the classes required to access the managed objects and their attributes. The NMF file(s) 39 supply mapping information between MIB tables and managed object classes.

With reference to FIG. 4, an embodiment of the parser(s) block 18 includes an MODL parser 40, a VDL parser 42, and an SNMP agent framework (SAF) parser 43. The VDL parser 42 is optional. The MODL parser 40 receives the MODL file(s) 36 and builds an intermediate representation of the file contents that includes a parse tree and object meta-data. The parse tree and object meta-data is provided to the code generator(s) 23 for generation of MODL and database management code. The object meta-data is also provided to the VDL parser 42. The VDL parser 42 receives the VDL file(s) 38 and the object meta-data and builds view meta-data. The object meta-data and view meta-data are provided to the code generator(s) 23 for generation of VDL code. The SAF parser 43 receives MODL files created by the MIB converter and the NMF files and creates an output that is provided to the code generator(s) 23 for generation of SAF code.

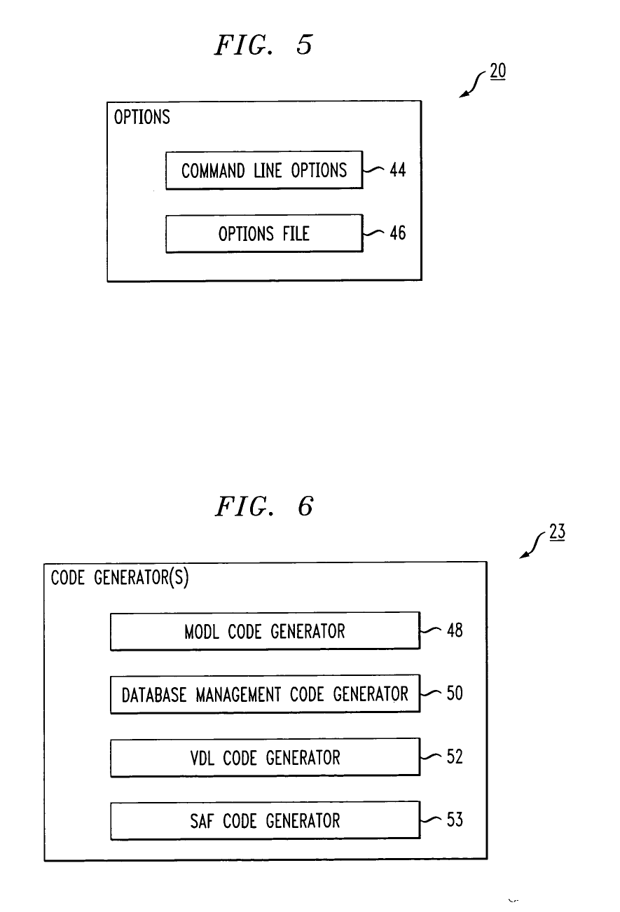

With reference to FIG. 5, an embodiment of the options block 20 includes command line options 44 and an options file 46. The options file 46 is optional. The command line options 44 include arguments and parameters to commands to initiate code generation. Various combinations of arguments and parameters are optional and permit developers to customize code generation to the current stage of application development and their current needs. The options file 46 is a sequence of commands in a file that similarly permit developers to customize code generation. The options file 46, for example, can specify reuse of code that was generated previously so that current code generation may be limited to areas that have changed.

With reference to FIG. 6, an embodiment of the code generator(s) block 23 includes an MODL code generator 48, a database management code generator 50, a VDL code generator 52, and an SAF code generator 53. The MODL code generator 48 receives the parse tree from the MODL parser 40 and instructions from the option(s) block 20 for generation of MODL code. The MODL code generator 48 generates code for instantiating and accessing the managed resources and objects in the network design from the MODL file(s) 36. The database management code generator 50 receives object meta-data from the MODL parser 40 and instructions from the option(s) block 20 for generation of database management code. The database management code generator 50 generates database schema for transient and/or persistent managed objects and trigger definitions for database updates from the MODL file(s) 36. The VDL code generator 52 receives view meta-data from the VDL parser 42 and instructions from the option(s) block 20 for generation of VDL code. The VDL code generator 52 generates code for defining managed object views from the MODL file(s) 36 and VDL file(s) 38. The SAF code generator 53 generates code for providing an SNMP interface to managed object resources.

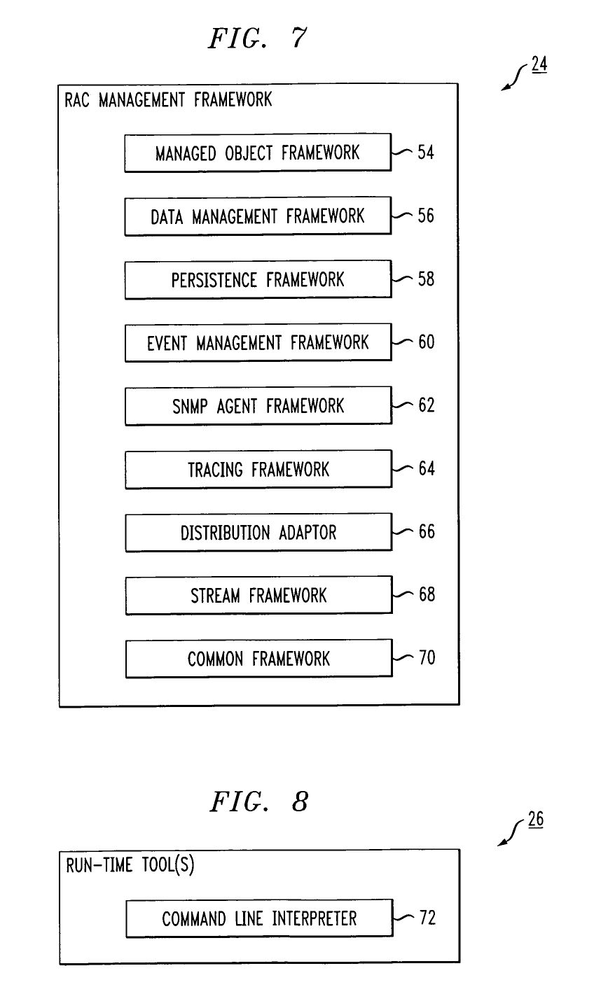

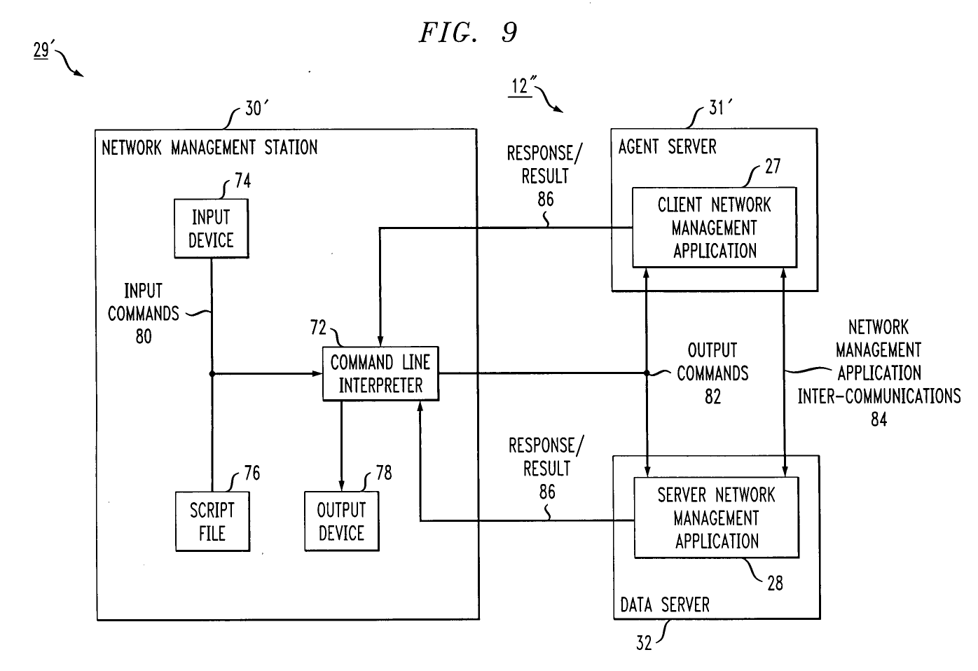

With reference to FIG. 7, an embodiment of the RAC management framework block 24 includes a managed object framework (MOF) 54, a data management framework (DMF) 56, a persistence framework (PF) 58, an event management framework (EMF) 60, an SNMP agent framework (SAF) 62, a tracing framework 64, a distribution adaptor (DA) 66, a stream framework 68, and a common framework 70. MOF 54 includes a set of classes that work in close cooperation to provide the management functionality of the network management applications. The MOF 54 is the core framework and provides object representations and interfaces for network management applications.

DMF 56 is used to make certain managed objects persistent and makes these persistent managed objects accessible to network management stations (NMSs). The DMF 56 also maintains consistency of the persistent data and permits various servers within the network design to share the data, for example, in real-time. PF 58 provides a portable persistent database interface to network management applications. This permits MODL and other coding for the applications to be developed transparent of any underlying database implementation.

EMF 60 includes a centralized event management server that performs event management routing and broadcasting. The EMF 60 unifies various system event generations and handling schemes into one uniform event processing model. SAF 62 provides network management applications with a gateway between MOF and SNMP protocols. SAF 62 acts as a proxy for SNMP protocol. SAF 62 also provides an interface definition language (IDL) interface through which other system elements can communicate using CORBA.

The tracing framework 64 provides network management applications with an option to emit tracing information that can be saved to a log file for subsequent problem analysis. The tracing framework 64 provides developers and users with multiple tracing levels. DA 66 is an adaptation layer framework for transparent distributed programming. DA 66 provides a pattern for utilizing client and server object proxies to allow code for distributed applications to be written without having to explicitly deal with distribution issues.

The stream framework 68 supports the encoding of objects into a stream and the complementary reconstruction of objects from the stream. The stream framework 68 permits objects to be passed by value from the client to the server through various communication mechanisms. The common framework 70 includes a set of utility classes that are used across the RAC management framework 24. The common framework 70 reduces redundancy across the RAC management framework 24, thereby reducing code for network management applications.

With reference to FIG. 8, an embodiment of the run-time tool(s) block 26 includes a command line interpreter 72. The command line interpreter 72 is a utility for monitoring and controlling managed objects associated with a network management application. The command line interpreter 72 includes interactive and batch modes of operation.

The command line interpreter 72 is a command line interface utility to manipulate managed objects on any managed object server via the network management application on the managed object server. The command line interpreter 72 may be used for provisioning the network during the network installation and also to perform the regression testing. The command line interpreter 72 responds to command line interpreter commands (i.e., input commands), such as “get.”In one embodiment, the command line interpreter 72, for example, may be referred to as a managed object framework command line interpreter (MOFCLI).

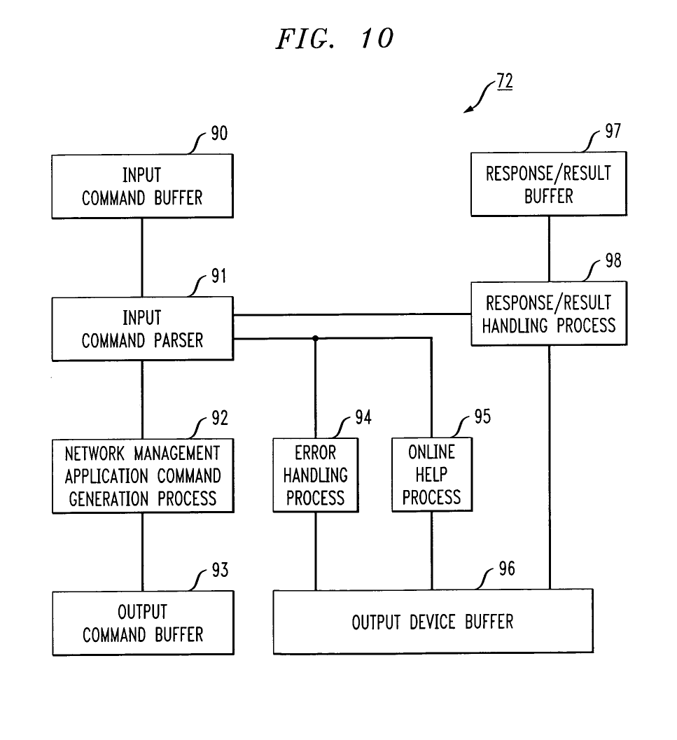

With reference to FIG. 9, an embodiment of a run-time network management environment 29′ with a command line interpreter 72 in communication with network management applications developed by the RAC development environment 10 (FIG. 1) includes a network management station 30′ and a network design 12″. The network design 12″, for example, includes an agent server 31′ and a data server 32. The network management station 30′ includes the command line interpreter 72, an input device 74, a script file 76, and an output device 78. The input device 74 may include any suitable keyboard, keypad, pointing device, and/or control device. The output device 78 may include any suitable display device, audio device, printer, storage device, and/or communication medium to a remote device. The agent server 31′ includes a client network management application 27 developed using the RAC development environment 10 (FIG. 1). The data server 32 includes a server network management application 28 developed using the RAC development environment 10 (FIG. 1).

The command line interpreter 72 can be either used in an interactive mode or a batch mode. In the interactive mode, the command line interpreter 72 accepts input commands 80 one at a time from the input device 74 and, when appropriate, sends one or more corresponding network management application commands (i.e., output commands 82) to one or more network management applications 27, 28 associated with the agent/data servers 31′, 32 based on the parsed input command. In the batch or non-interactive mode, the user specifies a script file 76 containing a sequence of input commands that are to be processed. Similar to the interactive mode, the input commands 80 are parsed by the command line interpreter 72 and, when appropriate, one or more output commands 82 are sent to one or more network management applications 27, 28 associated with the agent/data servers 31′, 32 based on the parsed input command.

Each input command 80 includes one or more constructs (i.e., parameter/argument), such as “distinguished name,” separated by space. The command line interpreter 72 reads one input command at a time and parses that command using a command parser. If the command parser does not find any errors in the input command, the command line interpreter 72 builds the one or more corresponding output commands 82 and sends the one or more output commands 82 to one or more network management applications 27, 28 associated with the agent/data servers 31′, 32. The output commands 86 may lead to network management application inter-communications 84. The output commands 86 may also lead to a response and/or result 86 communicated from a given network management application 27, 28 to the command line interpreter 72. A representation of the response/result 86 may be communicated from the command line interpreter 72 to the output device 78. When appropriate, the command line interpreter 72 waits for a response 86 to the one or more output commands 82 from the network management application 27 or 28 before parsing the next command. After an appropriate response 86 is received, the command line interpreter 72 is ready to parse the next command. If no response is received before a predetermined time or an inappropriate response is received, the command line interpreter 72 notifies an operator and may stop until the operator acknowledges or takes corrective action in conjunction with the response or lack of response.

With respect to the script file 76, each input command 80 is preferably written in a single line. However, if more than one line is necessary, a backslash “\” may be used at the end of a line to indicate continuation of the input command 80 to the next line. The end of the first line without a backslash “\” indicates the end of the input command 80.

The following constructs (i.e., parameters and/or arguments) may be used in input commands to the command line interpreter 72: distinguished name, attribute names, attribute name value pairs, attribute values, composite attribute values, and sequence attribute values. Of course, additional constructs may also be implemented.

A distinguished name (DN) construct is represented as set of node-name value pairs enclosed in parentheses “( ).” The syntax is:

(name=value, name=value,...).

The “name” is the name of the node as specified in the index declaration of a managed object in an MODL file and in the same order. If the node is not specified in the managed object containment tree or if the pairs are not in the proper order in the construct, an error is identified for the input command associated with the erroneous DN construct. Similarly, if there is no managed object associated with a given DN in the managed object containment tree, the DN construct is erroneous and an error is identified for the associated input command. An example of a DN is:

( BscCfg =1, Address=“192.21.98.120” ).

An attribute names construct is a list of names of the attributes separated by a double quote-comma-double quote sequence (“,”) or white space. This construct is used when the input command needs to send a list of attribute names to the network management application associated with the managed object server. The names of the attributes are the names specified in the MODL file. For example, AlarmLevel, AdminState, and OperState may be used as attribute names. Reserved keywords, such as “get,” should not be used as attribute names.

An attribute name value pairs construct is a list of pairs of attribute names and values. Each pair is separated by a double quote-comma-double quote sequence (“,”)or white space. This construct is used when the input command needs to send a list of attributes along with values for the attributes to the network management application associated with the managed object server. The syntax is:

name=value, name = value, ... .

The “name” is the name of the attribute and the “value” is the value specification of the attribute as explained below.

“stringify( )” is a method used in MOF Java to represent the value of an attribute in the form of string. The attribute value can later be unstringified. This method is used mainly to display the attribute values to the user and also a form in which to accept the attribute value from the user. The command line interpreter accepts the value of the attribute as specified in the stringify( ). Generally, any attribute value is represented in the stringify( ) method of that attribute. For example, a value for the attribute type “Integer” is represented as a plain integer, like 10, “IpAddress” is represented as dot separated integers like “192.200.100.10,” “DisplayString” is represented as a quoted string like “Test String,” etc. The enums are represented as a symbolic constant. An attribute value could be a structure, such as a composite attribute value structure, a sequence attribute value structure, or distinguished name attribute value structure.

A composite attribute value structure is represented as list of values within braces “{ }.” Given a composite attribute which contains Integer and two DisplayStrings, the value of the composite attribute can be represented as {1, “xxx”, “yyy”}. If one composite attribute contains another composite attribute, the value can be represented in a nested fashion such as {1, “xxx”, {1,“xxx”,“yyy”}}. It is an error If the value specification does not match the attribute specification declared in the MODL file, an the construct is erroneous and a error is identified in the associated input command.

A sequence attribute value construct is represented as list of values within brackets “[ ].” For example, a sequence of “Integer” that has three components is represented as [1, 23, 456]. A sequence of a composite attribute is represented as [{1, “xxx”, “yyy”}, {2, “zzz”, “www”}]. For backward compatibility, representations of sequence that uses brackets “[ ]” as delimiters (e.g., “1 [ ]23[ ]456[ ]”) are also supported in the input command parser. However, this practice is not recommended.

The command line interpreter 72 includes several quoting rules for attribute value. First, a double quote “ should be used on primary data types except for non-negative integers and enums. However, quoting non-negative integer and enums will not cause parsing errors. Additionally, do not quote whole structures such as distinguished names, composite attribute values and (new) sequence attribute value representations. Certain previous representations of sequence attribute values may be an exception to these rules. This includes quoting the whole sequence, whether an individual component is primary or structure. For example: “my test 1[ ]my test 2[ ]”, “100.129.1.1[ ]100.129.1.2[ ]”, “{1,xxx,yyy}[ ]{2,xxx,yyy}[ ]”.

The following input commands 80 may be used in conjunction with the command line interpreter 72: get, getfirst, getnext, set, create, delete, getdn, action, info, walk, bulkget, help, verbose, exit, and quit. Each input command 80 has a syntax for the command, constructs, and arguments associated therewith. Certain constructs/arguments may be optional. Optional constructs/arguments are enclosed in brackets “[ ]” in the syntax examples provided below. During parsing, if the syntax associated with an input command fails, the command line interpreter 72 generates an error message starting with three asterisks “***” and communicates the error message to the output device 78.

The input command “get” retrieves specified attributes from a specified data server 32 given its distinguished name and the attribute names. The syntax is:

get <distinguished name> <attribute names|all>

The values of the attributes are provided in a response/result 86 from the network design 12′, for example, the data server 32 and communicated to the output device 78. If “all” is specified in the attribute argument, then all attribute values for this DN will be provided in the response/result 86 and communicated to the output device 78. Examples of input commands and corresponding information provided to the output device 78 are provided below.

INPUT COMMAND:
get (BscCfg=1, BtsCfg=1) all
CORRESPONDING RESPONSE/RESULT INFORMATION:
Attributes: DisplayString Descr=“junk”, NeType Type=bts,
DisplayString Name=“Bts1”, DisplayString
Contact=“Shankar”, DisplayString Location=“67 Whippany
Road”, Integer NoOfSectors=3
INPUT COMMAND:
get (BscCfg=1, BtsCfg=1) Type what Contact
CORRESPONDING ERROR INFORMATION:
*** Invalid attribute name: what, definition is not found
in MO: C2k.BtsCfg!

The input command “getfirst” retrieves specified attributes from the first instance of a managed object class specified in the command argument from the containment tree hierarchy generated from the MODL files. The syntax is:

getfirst <class name> <attribute names|all>,

where the <class name> is the name of the managed object specified in the class declaration of corresponding MODL files. Examples of input commands and corresponding information provided to the output device 78 are provided below.

INPUT COMMAND:
getfirst C2k.Bts1 all
CORRESPONDING ERROR INFORMATION:
*** Invalid MO: C2k.Bts1, definition is not found!
INPUT COMMAND:
getfirst C2k.BtsCfg all
CORRESPONDING RESPONSE/RESULT INFORMATION:
Attributes: DisplayString Descr=“junk”, NeType Type=bts,
DisplayString Name=“Bts1”, DisplayString
Contact=“Shankar”, DisplayString Location=“67 Whippany
Road”, Integer NoOfSectors=3

The input command “getnext” retrieves specified attributes from the next instance of a managed object specified in the command argument. The syntax is:

getnext [[<distinguished name>] <attribute names>|all].

If “distinguished name” is not specified, then the last distinguished name used in a previous command, such as get, getfirst, etc., is used for the current getnext command. Likewise, if “attribute names” are not specified, the last attribute names used in a previous command, such as get, getfirst, etc., is used for the current getnext command. If there is no previous distinguished name or no previous attribute names when a corresponding construct is not specified in the getnext command, an error condition exists which is identified by the command line interpreter 72 and an error message is provided to the output device 78. Examples of input commands and corresponding information provided to the output device 78 are provided below.

INPUT COMMAND:
getnext
CORRESPONDING RESPONSE/RESULT INFORMATION:
Dn: (BscCfg=1, BtsCfg=1)
Attributes: DisplayString Descr=“junk”, NeType Type=bts,
DisplayString Name=“Bts1”, DisplayString
Contact=“Shankar”, DisplayString Location=“67 Whippany
Road”, Integer NoOfSectors=3
INPUT COMMAND:
getnext Name Type
CORRESPONDING RESPONSE/RESULT INFORMATION:
Dn: (BscCfg=1, BtsCfg=2)
Attributes: DisplayString Name=“Bts1”, NeType Type=bts

The input command “set” modifies the value of specified attributes of a managed object instance in a specified data server 32. The syntax is:
set <distinguished name> <attribute name value pairs>

After modifying the attributes, the new values may be verified using the get command. Examples of input commands and corresponding information provided to the output device 78 are provided below.

INPUT COMMAND:
set (BscCfg=1,BtsCf=1) Type=bts
CORRESPONDING ERROR INFORMATION:
*** BtsCf not found in the management tree
*** Odl parse exception occurred
*** Invalid distinguished name: (BscCfg=1, BtsCf=1)!
INPUT COMMANDS:
set (BscCfg=1,BtsCfg=1) Descr=“test”, Name=“Bsc Demo”
NoOfSectors=3
get (BscCfg=1, BtsCfg=1) Descr, Name
CORRESPONDING RESPONSE/RESULT INFORMATION:
Attributes: DisplayString Descr=“test”, DisplayString
Name=“Bsc Demo”, Integer NoOfSectors=3

The input command “create” creates a specified managed object in a specified data server 32. The syntax is:

create <distinguished name> <attribute values>

Examples of input commands and corresponding information provided to the output device 78 are provided below.

INPUT COMMAND:
create (BscCfg=1, BtsCfg=1, SectorCfg=alpha) HwGrpUsed=0
CORRESPONDING RESPONSE/RESULT INFORMATION:
*** Create (BscCfg=1, BtsCfg=1, SectorCfg=alpha) failed!
*** RubyError: no=207, Managed Object Already Exists
INPUT COMMAND:
create (BscCfg=1, BtsCfg=1, SectorCfg=omni) HwGrpUsed=0
CORRESPONDING RESPONSE/RESULT INFORMATION:
Created Dn: (BscCfg=1, BtsCfg=1, SectorCfg=omni)
INPUT COMMAND (after above create command):
get (BscCfg=1, BtsCfg=1) HwGrpUsed
CORRESPONDING RESPONSE/RESULT INFORMATION:
Attributes: Integer HwGrpUsed=0

The input command “delete” deletes a specified managed object instance on a specified data server 32. The syntax is:

delete <distinguished name>

Examples of input commands and corresponding information provided to the output device 78 are provided below.

```
INPUT COMMAND:
delete (BscCfg=1, BtsCfg=1, SectorCfg=)
CORRESPONDING ERROR INFORMATION:
*** Encountered “)” at line 1, column 39.
Was expecting one of:
    <INTEGER_LITERAL> ...
    <STRING_LITERAL> ...
    <IDENTIFIER> ...
    “(” ...
    “{” ...
    “[” ...
INPUT COMMAND:
delete (BscCfg=1, BtsCfg=1, SectorCfg=omni)
CORRESPONDING RESPONSE/RESULT INFORMATION:
Deleted (BscCfg=1, BtsCfg=1, SectorCfg=omni)
successfully.
```

The input command “getdn” retrieves distinguished names without associated attributes for a specified managed object class. If “all” is specified as an argument, then all DNs are retrieved from the data server 32. The syntax is

getdn <MO class name>|all

Examples of input commands and corresponding information provided to the output device 78 are provided below.

```
INPUT COMMAND:
getdn C2k.BtsCfg
CORRESPONDING RESPONSE/RESULT INFORMATION:
Mo C2k.BtsCfg
      Dn: (BscCfg=1, BtsCfg=1)
      Dn: (BscCfg=1, BtsCfg=2)
      Dn: (BscCfg=1, BtsCfg=3)
```

The input command “action” delivers a specified action to a managed object instance with a specified distinguished name. If the command is successful, the output parameters associated with the action are provided in the response/result 86. The syntax is:

action <dn specification> <action name> [<input parameter
name value pairs>]

<dn specification> is specification of a distinguished name of the managed object on which action will be delivered. The <input parameter name value pairs> are name value pairs of input parameters. Examples of input commands and corresponding information provided to the output device 78 are provided below.

INPUT COMMAND:
action (BscDynamic=1,BtsDynamic=2) setIdentity \
dn=(BscDynamic=1,BtsDynamic=2) name=“tico” ip=”135.1.1.1”
CORRESPONDING ERROR INFORMATION:
*** Action Failed!
*** RubyError: no=204, Managed Object Not Found ,
Description=BscDynamic.1.BtsDynamic.2.

The input command “info” retrieves information about attributes that is contained in a specified managed object class, including its index. The syntax is:

info <class name> | all

The <class name> is the name of the managed object specified in the class declaration of the corresponding MODL files. The response/result 86 for this command includes information about the specified <class name>, which in turn is provided to the output device 78. If “all” is specified as an argument, then index and attribute information about all known managed object classes are retrieves. Examples of input commands and corresponding information provided to the output device 78 are provided below.

INPUT COMMAND:
info C2k.BtsCfg
CORRESPONDING RESPONSE/RESULT INFORMATION:
Information for C2k.BtsCfg:
Dn: (BscCfg=1, BtsCfg=0)
Attributes: DisplayString Descr=“”, NeType Type=bts,
DisplayString Name=“”, DisplayString Contact=“”,
DisplayString Location=“”, Integer NoOfSectors=0

The input command “walk” browses all the instances of a specified managed object class. The syntax is:
walk <class name> | all

The <class name> is the name of the managed object specified in the class declaration of MODL files. This browses all the instances of <class name>. The response/result 86 for this command includes all the instances of <class name>, which in turn are made accessible to the user via the output device 78. If “all” is specified as an argument, the command browses all instances of all known managed object classes and makes them all accessible to the user. Examples of input commands and corresponding information provided to the output device 78 are provided below.

INPUT COMMAND:
walk C2k.BtsCfg
CORRESPONDING RESPONSE/RESULT INFORMATION:
Walking the mo C2k.BtsCfg
Dn: (BscCfg=1, BtsCfg=1)
Attributes: DisplayString Descr=“junk”, NeType Type=bts,
DisplayString Name=“Bts1”, DisplayString
Contact=“Shankar”, DisplayString Location=“67 Whippany
Road”, Integer NoOfSectors=3
Dn: (BscCfg=1, BtsCfg=2)
Attributes: DisplayString Descr=“junk”, NeType Type=bts,
DisplayString Name=“Bts1”, DisplayString
Contact=“Shankar”, DisplayString Location=“”, Integer
NoOfSectors=3

The input command “bulkget” retrieves the attributes of multiple managed objects from various data servers 32 based on a specified root distinguished name, specified attribute names, and optional level parameters. “All” or “none” may be specified for the attribute names parameter. The syntax is:

bulkget <distinguished name> <attribute names>|all|none
[levelN]

The retrieved managed object tree is included in the response/result for this command and may, for example, be displayed and/or printed via the output device 78. The “all” or “none” parameter allows the user to retrieve either all attributes or no attributes when attribute names are not specified. The optional “levelN” parameter lets the user control the number of tree levels of the managed object tree to retrieve. For example, level3 retrieves up to three levels below the specified root distinguished name. All levels are retrieved if levelN is not specified. Examples of input commands and corresponding information provided to the output device 78 are provided below. The output device may, for example, display the retrieved attributes and corresponding managed objects distinguished name. The retrieved data may be displayed in a bottom up format where the specified root distinguished name is displayed at the bottom. The response/result information may be indented to make it easier for the user to navigate the retrieved managed objects tree.

INPUT COMMAND:
bulkget (BscCfg=1) Descr
CORRESPONDING RESPONSE/RESULT INFORMATION:
Dn: (BscCfg=1)
Attributes: DisplayString Descr=“BSC”
Dn: (BscCfg=1, BtsCfg=1)
Attributes: DisplayString Descr=“junk”
Dn: (BscCfg=1, BtsCfg=1, SectorCfg=alpha)
Dn: (BscCfg=1, BtsCfg=1, SectorCfg=beta)
Dn: (BscCfg=1, BtsCfg=1, SectorCfg=gamma)
Dn: (BscCfg=1, BtsCfg=2)
Attributes: DisplayString Descr=“junk”
Dn: (BscCfg=1, BtsCfg=2, SectorCfg=alpha)
Dn: (BscCfg=1, BtsCfg=2, SectorCfg=beta)
Dn: (BscCfg=1, BtsCfg=2, SectorCfg=gamma)
Dn: (BscCfg=1, BtsCfg=3)
Attributes: DisplayString Descr=“junk”
Dn: (BscCfg=1, BtsCfg=3, SectorCfg=alpha)
Dn: (BscCfg=1, BtsCfg=3, SectorCfg=beta)
Dn: (BscCfg=1, BtsCfg=3, SectorCfg=gamma)

The input command “help” directs online help information regarding input commands and other aspects of the command line interpreter 72 to the output device 78. For example, the help information may be displayed or printed via the output device 78. If no argument is specified, general syntax information is provided. If a command argument is specified, detailed information about that command is provided. The syntax is:

help [MofCli command]

The input command “verbose” turns ON or OFF verbose messages output. The verbose messages help debug input commands, including script files, when an error occurs. The command syntax is:

verbose on|off

The input commands “exit” and “quit” exit from the command line interpreter.

If an ampersand “#” is encountered in a command, the command line interpreter ignores the remainder of that command. The command line interpreter ignores empty or blank lines.

The command line interpreter is activated in accordance with the following command line usage:

MofCli −m modlFile [−s scriptFile] [−h hostname] [−p
portno] [−q] [−v] [−j [−o optionFile] [−d
jdbc_port_number] ]

The -m option specifies the MODL file. This option must be specified in the command line. Multiple MODL files can be specified in the command line, for example, as -m x.odl -m y.odl. This will be used by the command line interpreter 72 to build the management information tree.

The -s option is used to run the command line interpreter 72 in batch mode. The script files consists of input commands that will be processed by the command line interpreter, and if necessary, sent to one or more agent/data servers 31 ′, 32. The default mode is interactive mode, where it accepts input commands from the input device 74. One script file may be specified for the command using the script file option.

The -h option specifies the remote host name where the agent/data server 31′, 32 resides. If this option is not specified, the managed object server is assumed to be in the current host.

The -p option is used to specify the Interoperable Object Reference(IOR) port of the agent/data server 31′, 32. This utility first sends a UDP message to the agent/data server 31′, 32 at IOR port to get its IOR. Once the IOR is obtained, subsequent communication are through CORBA. If this option is not specified, the managed object server is assumed at port 10000.

The -q option forces the command line interpreter to quit when an error occurs. By default, the command line interpreter continues to execute the next line if an error occurs.

The -v option turns on verbose messages. By default, verbose messages from the command line interpreter are turned off.

The -j option gives the command line interpreter direct jdbc access to the SQL server. Optionally, the user can pass the option file with -o and/or jdbc port to use with the -d option. A schema name or long name truncation flag can be specified in the option file. By default, the schema name is blank “ ” and there is no long (>32) attribute name truncation.

The following input command keywords should not be used as attribute names: get, getfirst, getnext, getdn, set, create, delete, info, walk, bulkget, action, help, verbose, exit, quit, on, off, all, none, and level1-level9. This limitation is also a limitation on the MODL language files.

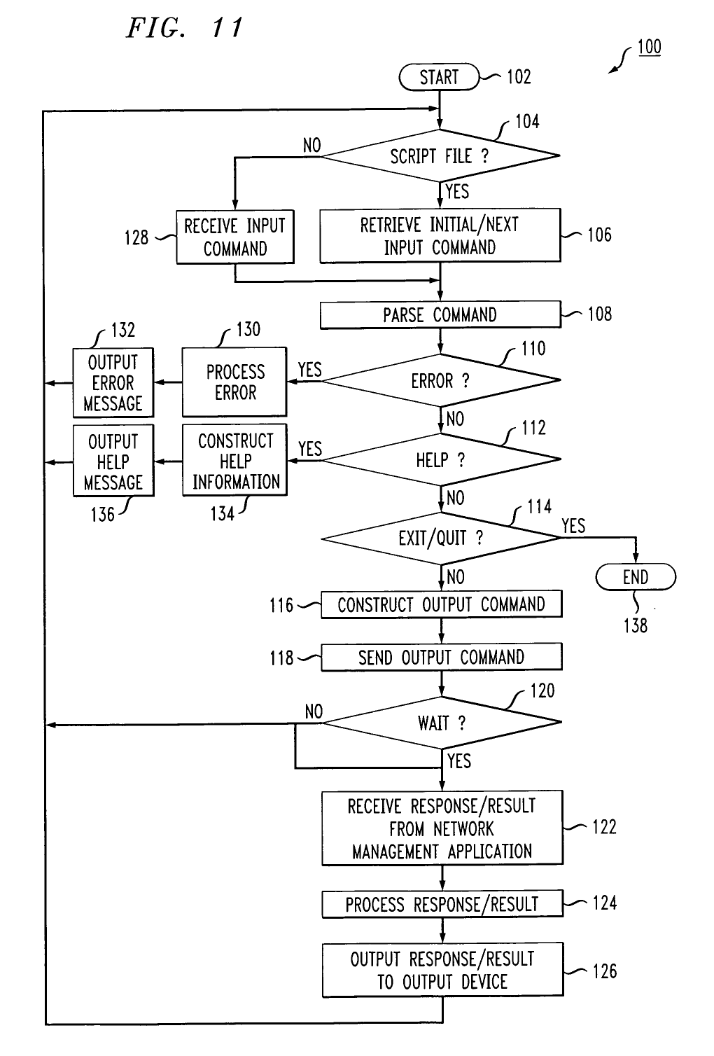

With reference to FIG. 10, an embodiment of the command line interpreter 72 includes an input command buffer 90, an input command parser 91, a network management application command generation process 92, an output command buffer 93, an error handling process 94, an online help process 95, an output device buffer 96, a response/result buffer 97, and a response/result handling process 98.

The input command buffer 90 receives input commands from either the input device 74 (FIG. 9) or the script file 76 (FIG. 9) and stores one or more commands for use by the command line interpreter 72. The input command parser 91 retrieves an input command from the input command buffer 90 and parses the command according to the associated syntax. The input command parser 91 may also receive information from the response/result handling process 98 so that parser operations can be based on certain response/results 86 (FIG. 9) received by the command line interpreter 72. If the input command parser 91 detects an error associated with the command or its syntax, input command information is communicated to the error handling process 94, otherwise, depending on the input command being parsed, command information is communicated to either the network management command generation process 92 or the online help process 95.

The error handling process 94 receives input command information when an error is detected in the corresponding input command. Error information and a corresponding error message is constructed and provided to the output device 78 via the output device buffer 96. If verbose messages are turned on, the error handling process 94 may include an appropriate verbose message in the error information.

The network management application command generation process 92 receives input command information associated with network management application commands (i.e., output commands 82 (FIG. 9)) and constructs one or more output commands based on the parsed input command. The output commands are provided to the agent/data servers 31′, 32 (FIG. 9) via the output command buffer 93.

The online help process 95 receives input command information associated with the input command “help” and constructs help information based on the parsed “help” input command. The help information is provided to the output device 78 (FIG. 9) via the output device buffer 96.

After an output command 82 (FIG. 9) is sent to an agent/data server 31′, 32 (FIG. 9), the agent/data server may send a response/result 86 (FIG. 9) to the command line interpreter 72. The response/result buffer 97 is received and stored by the response/result buffer 97. The response/result handling process 98 retrieves the response/result information from the response/result buffer 97 and processes the information for distribution within the command line interpreter 72. The response/result handling process 98 may provide certain response/result information to the input command parser 91 as feedback and/or for determining the next parser action. The response/result handling process 98 also provides response/result information to the output device 78 (FIG. 9) via the output device buffer 96.

The various components of the command line interpreter 72 described above may be implemented by hardware, software, and/or combinations thereof

With reference to FIG. 11, an operational process 100 for an embodiment of the command line interpreter begins at step 102 when the command line interpreter is activated via, for example, the MofCli command described above. At step 104, the process determines if a script file with input commands to be executed in a batch fashion was received. If a script file was received, the initial input command from the script file is retrieved (step 106). At step 108, the input command is parsed by the parser. Next, the parser determines if there is an error associated with the input command (step 110). At step 112, if there is no error during parsing, the process may determine if the input command is help. Next, if the input command is not help, the process may determine if the input command is exit or quit (step 114). If the input command is not exit or quit, the input command may be associated with generation of one or more output commands to network management applications associated with one or more agent/data servers 31′, 32 (FIG. 9) associated with the network design 12′(FIG. 9).

At step 116, the network management application command generation process constructs one or more output commands. Next, the network management application command generation process sends the one or more output commands to network management applications associated with one or more agent/data servers (step 118). At step 120, the process determines if it must wait for a certain response/result to be returned from the one or more agent/data servers before continuing on to the next input command. Next, if the process must wait, the command line interpreter receives a response/result from the network management applications associated with the one or more agent/data servers (step 122). At step 124, the response/result handling process processes the response/result to create response/result information. Next, the response/result information is output to the output device 78 (FIG. 9) (step 126). At this point, the process returns to step 104 to process the next input command. The next input command may be selected based on the response/result information associated with the last input command.

At step 104, if a script file was not received, the process waits until it receives a manual input command (step 128). When a manual input command is received, the process continues with step 108 as described above.

At step 110, if an error is detected, the error handling process processes the error (step 130). Next, an error message associated with the detected error is output to the output device (step 132) and the process returns to step 104 to process the next input command. In an alternate embodiment, if the command line interpreter is activated with the appropriate parameters to end on detection of an error, the process ends after step 132 instead of processing another input command.

At step 112, if the input command is help, the online help process constructs help information based on the parsed input command (step 134). Next, a help message associated with the parsed input command is output to the output device (step 136) and the process returns to step 104 to process the next input command.

At step 114, if the input command is exit or quit, the process ends at step 138.

At step 120, if the process does not have to wait for the response/result before processing the next input command, the process advances to steps 104 and 122 in parallel. Thus, beginning to process the next input command while processing the response/result from the previous input command.

In an alternate embodiment, verbose messages may be turned on when the command line interpreter is activated or when a verbose input command is processed. With verbose messages on, the error processing and messaging in steps 130 and 132 include construction and output of verbose messages in place of or in addition to the normal error messages.

The various steps in the foregoing process 100 may be implemented by hardware, software, and/or combinations thereof within the command line interpreter 72.

The above description merely provides a disclosure of particular embodiments of the invention and is not intended for the purposes of limiting the same thereto. As such, the invention is not limited to only the above-described embodiments. Rather, it is recognized that one skilled in the art could conceive alternate embodiments that fall within the scope of the invention.

We claim:

1. A method of monitoring and controlling managed objects within a distributed system by manipulating one or more management application programs associated with the distributed system, the method including the steps:
a) providing a run-time tool associated with a management station, wherein the management station is in communication with the distributed system and the run-time tool is in communication with the one or more management application programs, wherein the run-time tool is activated by an activation command having a predetermined syntax, wherein the run-time tool responds to a plurality of input commands, each input command having a predetermined syntax, wherein the run-time tool response to certain input commands is to generate one or more corresponding management application commands and send the generated management application commands to at least one management application program based on the input command;
b) activating the run-time tool in response to receiving a first activation command;
c) receiving a first input command;
d) parsing the first input command to determine whether the first input command is in accordance with a corresponding predetermined syntax;
e) when the first input command is in accordance with the corresponding predetermined syntax, generating one or more management application commands based on the parsed first input command; and
f) sending the one or more generated management application commands to at least one management application program, wherein the management application program(s) to which the one or more generated management application commands are sent is based on the first input command.

2. The method as set forth in claim 1 wherein the distributed system is a network.

3. The method as set forth in claim 2 wherein the network is a telecommunication network.

4. The method as set forth in claim 1 wherein the management application programs were developed using a reusable asset center development environment.

5. The method as set forth in claim 1 wherein the management application programs are based on an object-oriented resource definition language and monitor and control the managed objects in response to management application commands associated with the object-oriented resource definition language.

6. The method as set forth in claim 1 wherein the run-time tool is a command line interpreter.

7. The method as set forth in claim 1 wherein the predetermined syntax for the activation command is MofCli -m modlFile [-s scriptFile] [-h hostname] [-p portno] [-q] [-v] [-j[-o optionFile] [-d jdbc_port_number]] where parameters enclosed in brackets [ ] are optional.

8. The method as set forth in claim 1 wherein the plurality of input commands include at least one of a “get” command, a “getfirst” command, a “getnext” command, a “getdn” command, a “set” command, a “create” command, a “delete” command, an “info” command, a “walk” command, a “bulkget” command, an “action” command, a “help” command, a “verbose” command, an “exit” command, and a “quit” command.

9. The method as set forth in claim 8 wherein the predetermined syntax for the “get” command is get <distinguished name> <attribute names|all>.

10. The method as set forth in claim 8 wherein the predetermined syntax for the “getfirst” command is getfirst <class name> <attribute names|all>.

11. The method as set forth in claim 8 wherein the predetermined syntax for the “getnext” command is getnext [[<distinguished name>] <attribute names>|all] where parameters enclosed in brackets [ ] are optional.

12. The method as set forth in claim 8 wherein the predetermined syntax for the “getdn” command is getdn <MO class name>|all.

13. The method as set forth in claim 8 wherein the predetermined syntax for the “set” command is set <distinguished name> <attribute name value pairs>.

14. The method as set forth in claim 8 wherein the predetermined syntax for the “create” command is create <distinguished name> <attribute values>.

15. The method as set forth in claim 8 wherein the predetermined syntax for the “delete” command is delete <distinguished name>.

16. The method as set forth in claim 8 wherein the predetermined syntax for the “info” command is info <class name> | all.

17. The method as set forth in claim 8 wherein the predetermined syntax for the “walk” command walk <class name> | all.

18. The method as set forth in claim 8 wherein the predetermined syntax for the “bulkget” command is bulkget <distinguished name> <attribute names>|all|none [levelN] where parameters enclosed in brackets [ ] are optional.

19. The method as set forth in claim 8 wherein the predetermined syntax for the “action” command is action <dn specification> <action name> [<input parameter name value pairs>] where parameters enclosed in brackets [ ] are optional.

20. The method as set forth in claim 8 wherein the predetermined syntax for the “help” command is help [MofCli command] where parameters enclosed in brackets [ ] are optional.

21. The method as set forth in claim 8 wherein the predetermined syntax for the “verbose” command is verbose on|off.

22. The method as set forth in claim 1 wherein the first activation command received in step b) at least includes a parameter identifying a script file containing a list of input commands and the first input command received in step c) is retrieved from a first end of the list of input commands.

23. The method as set forth in claim 22 wherein steps c)-f) are repeated for each input command in the list of input commands in a sequence beginning at the first end of the list and advancing sequentially to a second end of the list.

24. The method as set forth in claim 1 wherein the first input command received in step c is received from an input device in communication with the run-time tool.

25. The method as set forth in claim 1, further including the steps:
g) when the first input command is not in accordance with the corresponding predetermined syntax, detecting an error in the first input command and performing an error handling process to construct an error message based on the first input command; and
h) sending the error message to an output device in communication with the run-time tool.

26. The method as set forth in claim 1 wherein a verbose messaging capability is turned on via a verbose parameter in the first activation command or a verbose input command and the error message constructed in step g) includes a verbose message.

27. The method as set forth in claim 1 wherein the run-time tool response to at least one input command is to construct an online help message corresponding to the at least one input command and send the online help message to an output device in communication with the run-time tool, the method further including the steps:
g) receiving a second input command;
h) parsing the second input command to determine whether the second input command is in accordance with a corresponding predetermined syntax;
i) when the second input command is in accordance with the corresponding predetermined syntax, constructing an online help message based on the parsed second input command; and
j) sending the online help message to the output device.

28. The method as set forth in claim 1, further including the steps:
g) receiving response/result information from the management application program(s) to which the one or more generated management application commands were sent;
h) processing the response/result information to construct a response/result message; and
i) sending the response/result message to an output device in communication with the run-time tool.

29. The method as set forth in claim 28 wherein the response/result information received in step g) is considered before repeating at least steps c)-f) for a second input command.

30. A method of monitoring and controlling managed objects within a distributed system by manipulating one or more management application programs associated with the distributed system, the method including the steps:
a) providing a run-time tool associated with a management station, wherein the management station is in communication with the distributed system and the run-time tool is in communication with the one or more management application programs, wherein the run-time tool is activated by an activation command having a predetermined syntax, wherein the run-time tool responds to a plurality of input commands, each input command having a predetermined syntax, wherein the run-time tool response to certain input commands is to generate one or more corresponding management application commands and send the generated management application commands to at least one management application program based on the input command;
b) activating the run-time tool in response to receiving a first activation command with a parameter identifying a script file containing a list of input commands;
c) retrieving a first input command from a first end of the list of input commands in the script file;
d) parsing the first input command to determine whether the first input command is in accordance with a corresponding predetermined syntax;
e) when the first input command is in accordance with the corresponding predetermined syntax, generating one or more management application commands based on the parsed first input command;
f) sending the one or more generated management application commands to at least one management application program, wherein the management application program(s) to which the one or more generated management application commands are sent is based on the first input command; and
g) repeating steps c)-g) for each input command in the list of input commands advancing sequentially from the first end of the list of input commands to a second end.

31. An apparatus for monitoring and controlling managed objects within a distributed system by manipulating one or more management application programs associated with the distributed system, the apparatus including:
a run-time tool associated with a management station, wherein the management station is in communication with the distributed system and the run-time tool is in communication with the one or more management application programs, wherein the run-time tool is activated by an activation command having a predetermined syntax, wherein the run-time tool responds to a plurality of input commands, each input command having a predetermined syntax, wherein the run-time tool response to certain input commands is to generate one or more corresponding management application commands and send the generated management application commands to at least one management application program based on the input command;
means for activating the run-time tool in response to receiving a first activation command;
means for receiving a first input command;
means for parsing the first input command to determine whether the first input command is in accordance with a corresponding predetermined syntax;
means for generating one or more management application commands based on the, parsed first input command when the first input command is in accordance with the corresponding predetermined syntax; and
means for sending the one or more generated management application commands to at least one management application program, wherein the management application program(s) to which the one or more generated management application commands are sent is based on the first input command.

32. The apparatus as set forth in claim 31, further including:
means for detecting an error in the first input command and performing an error handling process to construct an error message based on the first input command when the first input command is not in accordance with the corresponding predetermined syntax; and
means for sending the error message to an output device in communication with the run-time tool.

33. The apparatus as set forth in claim 31 wherein the run-time tool response to at least one input command is to construct an online help message corresponding to the at least one input command and to send the online help message to an output device in communication with the run-time tool, the apparatus further including:
means for receiving a second input command;
means for parsing the second input command to determine whether the second input command is in accordance with a corresponding predetermined syntax;
means for constructing an online help message based on the parsed second input command when the second input command is in accordance with the corresponding predetermined syntax; and
means for sending the online help message to the output device.

34. The apparatus as set forth in claim 31, further including:
means for receiving response/result information from the management application program(s) to which the one or more generated management application commands were sent;
means for processing the response/result information to construct a response/result message; and
means for sending the response/result message to an output device in communication with the run-time tool.
